(19) United States
(12) Patent Application Publication
(10) Pub. No.: US 2005/0264478 A1
(43) Pub. Date: Dec. 1, 2005

(54) Plasma Display Panel (PDP)

(76) Inventors: Jae-Ik Kwon, Suwon-si (KR); Won-Ju Yi, Suwon-si (KR)

Correspondence Address: Robert E. Bushnell, Suite 300, 1522 K Street, N.W., Washington, DC, 20005-1202, US

(21) Appl. No.: 11/132,358

(22) Filed: May 19, 2005

(30) Foreign Application Priority Data
May 25, 2004 (KR) 10-2004-0037348

(51) Int. Cl. G09G 3/28

(52) U.S. Cl. 345/60

(57) ABSTRACT

A Plasma Display Panel (PDP) includes: a front substrate; a rear substrate opposite to the front substrate; a dielectric wall arranged between the front and rear substrates to define discharge cells together with the front and rear substrates; pairs of discharge sustaining electrodes separately arranged along respective discharge cells and including a plurality of X electrodes and a plurality of Y electrodes buried in the dielectric wall; address electrodes arranged on the rear substrate and buried in a dielectric layer; and first, second, and third color phosphor layers coated in the discharge cells; wherein sectional areas of the X and Y electrodes vary with discharge distances of the X and Y electrodes with respect to portions of the X and Y electrodes where a discharge starts.

### CLAIM OF PRIORITY

This application makes reference to, incorporates the same herein, and claims all benefits accruing under 35 U.S.C. §119 from an application for PLASMA DISPLAY PANEL earlier filed in the Korean Intellectual Property Office on May 25, 2004 and there duly assigned Serial No. 10-2004-0037348.

### BACKGROUND OF THE INVENTION

1. Field of the Invention

The present invention relates to a Plasma Display Panel (PDP), and more particularly, to a PDP including an improved discharge electrode for stable sustaining discharge.

2. Description of the Related Art

PDPs are flat display devices which inject and discharge a discharge gas between two substrates on which discharge electrodes are formed and excite fluorescent materials of phosphor layers using ultraviolet rays generated by the discharge of the discharge gas to embody figures, characters, or graphics.

U.S. patent Publication No. 04-189199 relates to a three-electrode reflection type PDP for improving luminous efficiency and preventing an address discharge firing voltage from increasing.

Japanese Patent Publication No. hei 04-273202 relates to a high luminous efficiency PDP for reducing power consumption of a bus line during discharge and improving use efficiency of light.

Japanese Patent Publication No. hei 04-235163 relates to a PDP for improving discharge efficiency.

Japanese Patent Publication No. hei 04-63239 relates to a PDP for improving luminous efficiency of fluorescent substances and increasing luminance.

Japanese Patent Publication No. hei 03-217461 relates to a PDP for improving luminous efficiency.

However, a PDP as noted above has the following problems.

In the PDP, a predetermined brightness value of an image is obtained from visible light generated from phosphor layers and transmitting a front substrate. However, pairs of discharge sustaining electrodes, a front dielectric layer, and a protective layer are formed on an inner surface of the front substrate. Thus, the transmittance of the visible light does not reach 60%, and accordingly, the conventional PDP cannot be used as a high efficiency flat display device.

The discharging starts in a discharge gap between X and Y electrodes of a whole discharge space and diffuses outside the X and Y electrodes. Thus, as an electric field is located away from the discharge gap, the strength of the electric field is weakened.

Since the discharge diffuses along the plane of the front substrate, the degree of use of the whole discharge space is low.

In order to solve the drawbacks of a three-electrode surface discharge PDP, changes in the arrangement of discharge electrodes to improve discharge efficiency have been studied and developed.

### SUMMARY OF THE INVENTION

The present invention provides a PDP including pairs of discharge sustaining electrodes arranged along a side of a discharge space to improve discharge efficiency.

The present invention also provides a PDP including pairs of discharge sustaining electrodes with an improved shape to achieve stable sustaining discharge.

According to one aspect of the present invention, a Plasma Display Panel (PDP) is provided comprising: a front substrate; a rear substrate opposite to the front substrate; a dielectric wall arranged between the front and rear substrates to define discharge cells together with the front and rear substrates; pairs of discharge sustaining electrodes separately arranged along respective discharge cells and including a plurality of X electrodes and a plurality of Y electrodes buried in the dielectric wall; address electrodes arranged on the rear substrate and buried in a dielectric layer; and first color, second color, and third color phosphor layers coated in the discharge cells; wherein sectional areas of the X and Y electrodes vary with discharge distances of the X and Y electrodes with respect to portions of the X and Y electrodes where a discharge starts.

The sectional areas of the X and Y electrodes preferably increase from facing portions of the X and Y electrodes toward opposing portions.

The sectional areas of the X and Y electrodes preferably increase from a center of the dielectric wall toward an edge of the dielectric wall.

As the discharge distances of the X and Y electrodes with respect to the portions from which the discharge starts increase, gaps between the X and Y electrodes and an inner surface of the dielectric wall preferably decrease.

The X electrodes are preferably arranged adjacent to the front substrate, the Y electrodes are preferably arranged adjacent to the rear substrate, and the X and Y electrodes are preferably separately arranged up and down.

As the X electrodes approach the front substrate, the sectional areas of the X electrodes preferably increase, and as the Y electrodes approach the rear substrate, the sectional areas of the Y electrodes preferably increase.

The pairs of discharge sustaining electrodes preferably extend in one direction of the front substrate, and the address electrodes preferably extend across the pairs of discharge sustaining electrodes.

The X electrodes preferably comprise ladder structures sequentially interconnected around the discharge cells.

The Y electrodes preferably comprise ladder structures sequentially interconnected around the adjacent discharge cells arranged in one direction of the front substrate.

The PDP preferably further comprises a barrier rib arranged between the dielectric wall and the rear substrate to have a shape corresponding to the dielectric wall, wherein the red, green, and blue phosphor layers are preferably coated on an inner surface of the barrier rib.

The PDP preferably further comprises a protective layer arranged on an inner surface of the dielectric wall to increase an emission of secondary electrons.

The first color, second color, and third color phosphor layers preferably respectively comprise red, green, and blue phosphor layers.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is an exploded perspective view of a cut-away of a PDP;

FIG. 2 is a cross-sectional view of a unit discharge cell of FIG. 1;

FIG. 3 is a view of the arrangement of discharge electrodes according to an embodiment of the present invention;

FIG. 4 is an exploded perspective view of a cut-away portion of a PDP according to an embodiment of the present invention;

FIG. 5 is an exploded perspective view of discharge electrodes of FIG. 4; and

FIG. 6 is a cross-sectional view of a unit discharge cell with which the PDP of FIG. 4 is combined.

### DETAILED DESCRIPTION OF THE INVENTION

Hereinafter, a PDP according to embodiments of the present invention are described in detail with reference to the attached drawings.

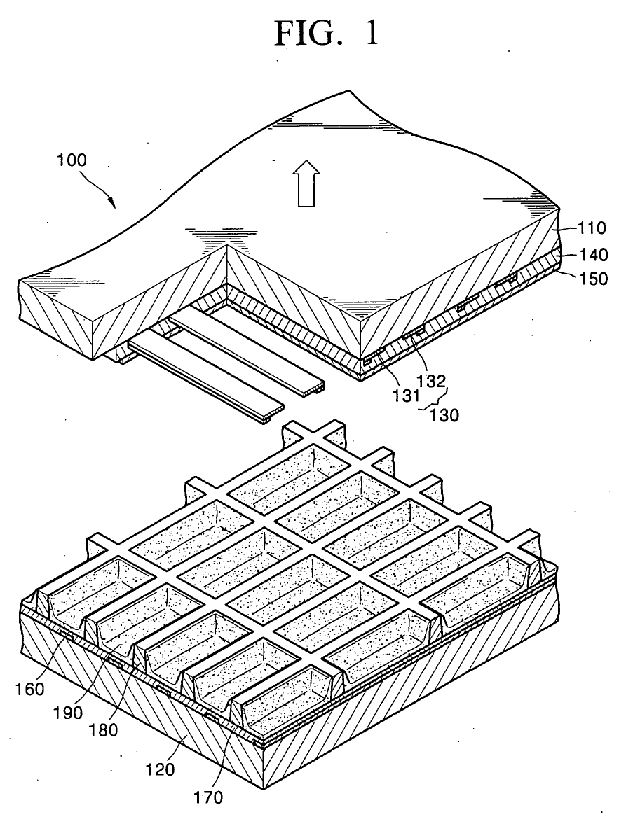

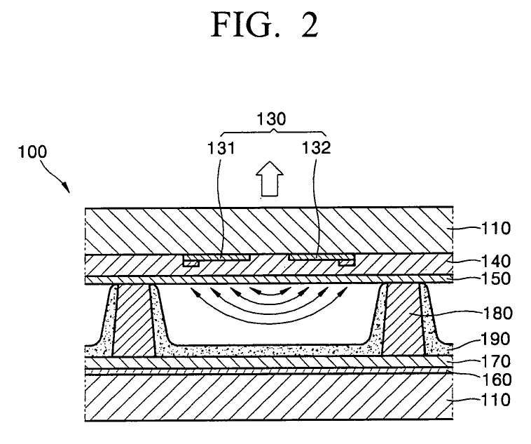

FIG. 1 is an exploded perspective view of a PDP 100, and FIG. 2 is a cross-sectional view of a unit discharge cell with which the PDP 100 of FIG. 1 is combined. Referring to FIGS. 1 and 2, the PDP 100 includes a front substrate 110 and a rear substrate 120 arranged opposite to the front substrate 110.

Pairs of discharge sustaining electrodes 130 including X electrodes 131 and Y electrodes 132 are formed on an inner surface of the front substrate 110. The X and Y electrodes 131 and 132 are alternately arranged along one direction of the front substrate 110. The pairs of discharge sustaining electrodes 130 are buried in a front dielectric layer 140. A Magnesium Oxide (MgO) protective layer 150 is deposited on the surface of the front dielectric layer 140.

Address electrodes 160 are formed on an inner surface of the rear substrate 120 so as to be arranged across the pairs of discharge sustaining electrodes 130. The address electrodes 160 are buried in a rear dielectric layer 170. A barrier rib 180 is formed on an upper surface of the rear dielectric layer 170 to define a discharge space and prevent cross-talk between adjacent discharge cells. The barrier rib 180 has a matrix shape. Red (R), Green (G), and Blue (B) phosphor layers 190 are coated on the barrier rib 180.

In order to drive the PDP 100 having the above-described structure, electrical signals are supplied to the Y electrodes 132 and the address electrodes 160 to select discharge cells of points at which the Y electrodes 132 and the address electrodes 160 cross. Next, electrical signals are alternately supplied to the X and Y electrodes 131 and 132 to produce surface discharge from the surface of the front substrate 110 so as to generate ultraviolet light rays. Visible light is emitted from the R, G, and B phosphor layers 190 coated on the selected discharge cells so as to realize still or moving pictures.

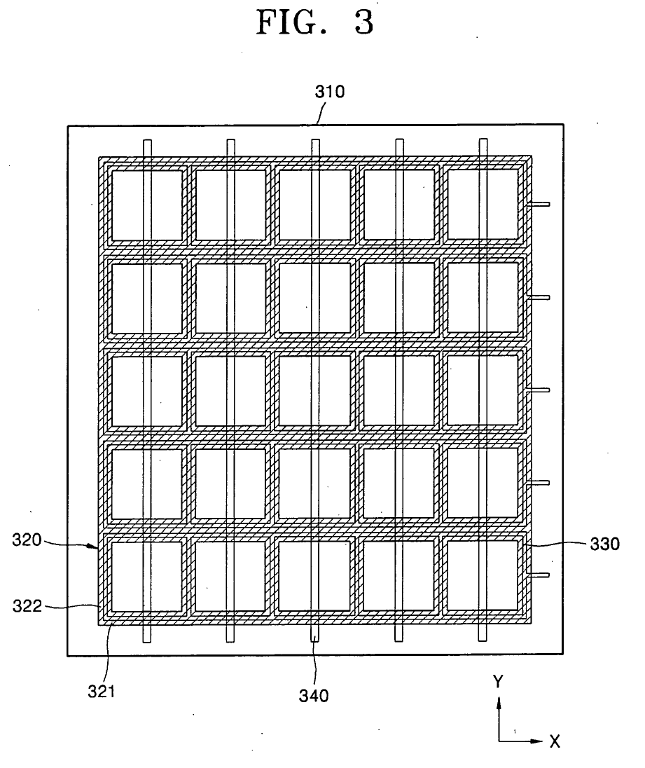

FIG. 3 is a view of a plurality of discharge electrodes arranged on a substrate 310 according to an embodiment of the present invention. Referring to FIG. 3, a dielectric wall 320 is arranged on the substrate 310 to define discharge cells. The dielectric wall 320 includes first dielectric walls 321 arranged in an X direction and second dielectric walls 322 arranged in a Y direction. The first and second electric walls 321 and 322 are combined with each other to form a matrix. Alternatively, the dielectric wall 320 can be formed in a meander shape, a delta shape, a honeycomb shape, or the like. The discharge cells can any shape to be defined by the dielectric wall 320, for example, a square, a hexagon, an ellipse, a round shape, or the like.

First discharge electrodes 330 are arranged on the dielectric wall 320. One of the first discharge electrodes 330 is arranged in a square shape around each of the discharge cells so as to have ladder structures sequentially interconnected around the discharge cells adjacently arranged in the X direction. Thus, the same voltage is supplied to the first discharge electrodes 330 arranged in the X direction. The first discharge electrodes 330 arranged in the Y direction are separated from each other so that the first discharge electrodes 330 arranged in the X direction are spaced apart from each other. Thus, different voltages are supplied to the first discharge electrodes 330 arranged in the Y direction.

Second discharge electrodes 340 are arranged on the discharge cells. The second discharge electrodes 340 can have any shape across the first discharge electrodes 330, and in the present embodiment they have strip shapes. The second discharge electrodes 340 are spaced apart from each other in the X direction, and different voltages are supplied to the adjacent second discharge electrodes 340.

The first and second discharge electrodes 330 and 340 can be two-electrodes or three-electrodes depending on whether the PDP 100 is an opposite discharge type or a surface discharge type. Also, a plurality of first discharge electrodes 330 and a plurality of second discharge electrodes 340 can be used. Alternatively, at least a plurality of first discharge electrodes 330 or at least a plurality of second discharge electrodes 340 can be used. Moreover, the first and second discharge electrodes 330 and 340 are buried in the dielectric wall 320 to be arranged around the respective discharge cells. Thus, the first and second discharge electrodes 330 and 340 are not limited to only one structure.

In an embodiment that will be described later, a three-electrode surface discharge PDP includes first discharge electrodes that are pairs of discharge sustaining electrodes including X and Y electrodes separately arranged up and down and second discharge electrodes that are address electrodes.

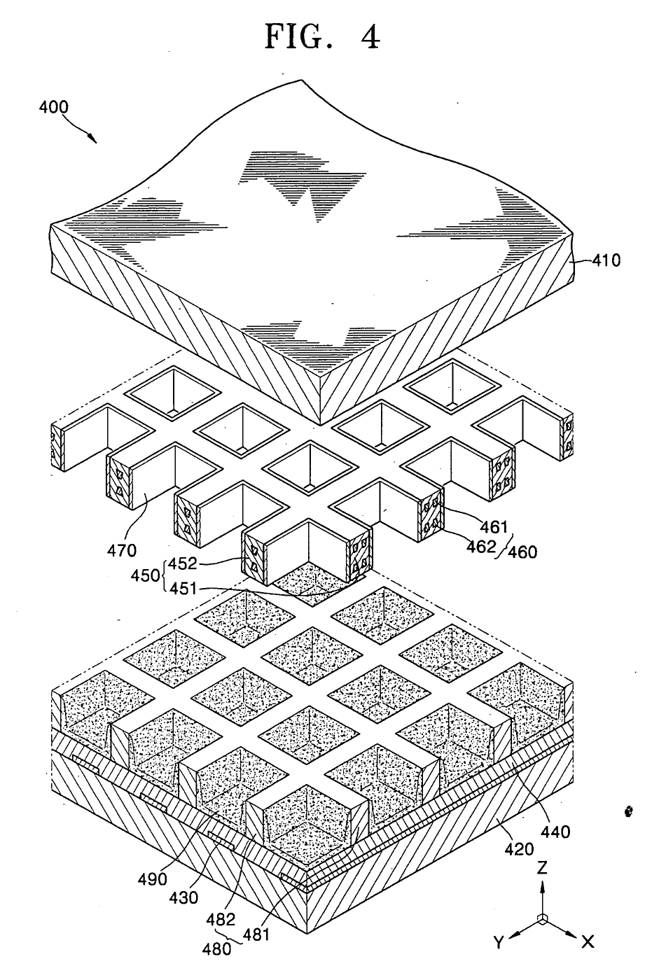

FIG. 4 is an exploded perspective view of a cut-away portion of a PDP 400 according to an embodiment of the present invention. Referring to FIG. 4, the PDP 400 includes a front substrate 410 and a rear substrate 420 arranged parallel with the front substrate 410. Frit glass coats opposite inner edges of the front and rear substrates 410 and 420 to seal the first and second substrates 410 and 420.

The first front substrate 410 is formed of transparent glass such as soda lime glass.

The rear substrate 420 is substantially formed of the same material as the front substrate 410. Address electrodes 430 are arranged on an inner surface of the rear substrate 420. The address electrodes 430 are formed of a plurality of strips and arranged parallel with a Y direction of the rear substrate 420. The address electrodes 430 are arranged across unit discharge cells and formed of a metallic material having good conductivity, for example, Silver (Ag) paste or multilayer structures of Chromium (Cr)-Copper (Cu)-Chromium (Cr).

The address electrodes 430 are buried in a dielectric layer 440. The dielectric layer 440 fully buries the address electrodes 430 using a transparent dielectric, for example, a high dielectric material such as PbO—B₂O₃—SiO₂. Alternatively, the dielectric layer 440 can selectively bury only portions at which the address electrodes 430 are formed.

A dielectric wall 450 is interposed between the front and rear substrates 410 and 420 to define a discharge space together with the front and rear substrates 410 and 420. The dielectric wall 450 is formed of a glass paste containing various fillers. The dielectric wall 450 includes first dielectric walls 451 arranged in a direction (X direction) orthogonal to the address electrodes 430 and second dielectric walls 452 arranged in a direction (Y direction) parallel with the address electrodes 430. The second dielectric walls 452 extend from inner sidewalls of the first dielectric walls 451 in an opposite direction to define a matrix type discharge space.

Alternatively, the dielectric wall 450 can have various shapes, for example, a meander shape, a delta shape, a honeycomb shape, a stripe shape, or the like. The discharge space can have any shape defined by the dielectric wall 450, for example, a square, a polygon, a round shape, or the like.

Pairs of discharge sustaining electrodes 460 are arranged on an inner surface of the dielectric wall 450. The pairs of discharge sustaining electrodes 460 include X electrodes 461 arranged relatively adjacent to the front substrate 410 and Y electrodes 462 arranged relatively adjacent to the rear substrate 420. The Y electrodes 462 are separately arranged under the X electrodes 461. The X and Y electrodes 461 and 462 are electrically insulated from each other and are supplied with different voltages.

The X and Y electrodes 461 and 462 are arranged around the respective discharge cells. Thus, the X and Y electrodes 461 and 462 form closed loops around the unit discharge cells. The sectional areas of the X and Y electrodes 461 and 462 vary with the discharge distances of the X and Y electrodes 461 and 462 with respect to the portions of the X and Y electrodes 461 and 462 where a discharge starts.

A protective layer 470 of a material, such as Magnesium Oxide (MgO), is deposited on the inner surface of the dielectric wall 450 along four sides of the discharge cells.

A barrier rib 480 can be additionally formed between the dielectric wall 450 and the rear substrate 420. The barrier rib 480 is formed of a low dielectric material that is different from that of the dielectric wall 450. The barrier rib 480 is substantially formed in the same shape as the dielectric wall 450 on a portion opposite to the dielectric wall 450.

In other words, the barrier rib 480 includes first barrier ribs 481 arranged in a direction (X direction) orthogonal to the address electrodes 430 and second barrier ribs 483 arranged in a direction (Y direction) parallel with the address electrodes 430. The first and second barrier ribs 481 and 482 form a single body in a matrix shape. When only the dielectric wall 450 is formed between the front and rear substrates 410 and 420, a single wall defines the discharge cells. When the dielectric wall 450 and the barrier rib 480 are formed between the front and rear substrates 410 and 420, a dual layer of different dielectric materials defines the discharge cells.

A mixed gas of Neon (Ne) and Xenon (Xe) or a mixed gas of Helium (He) and Xe is injected into the discharge cells partitioned by the front and rear substrates 410 and 420, the dielectric wall 450, and the barrier rib 480.

R, G, and B phosphor layers 490 are formed in the discharge cells and are excited by ultraviolet light rays generated by a discharge gas so as to emit visible light. The R, G, and B phosphor layers 490 can be coated on any surfaces of the discharge cells but are preferably coated on an inner surface of the barrier rib 480 and an upper surface of the dielectric layer 440 to a predetermined thickness.

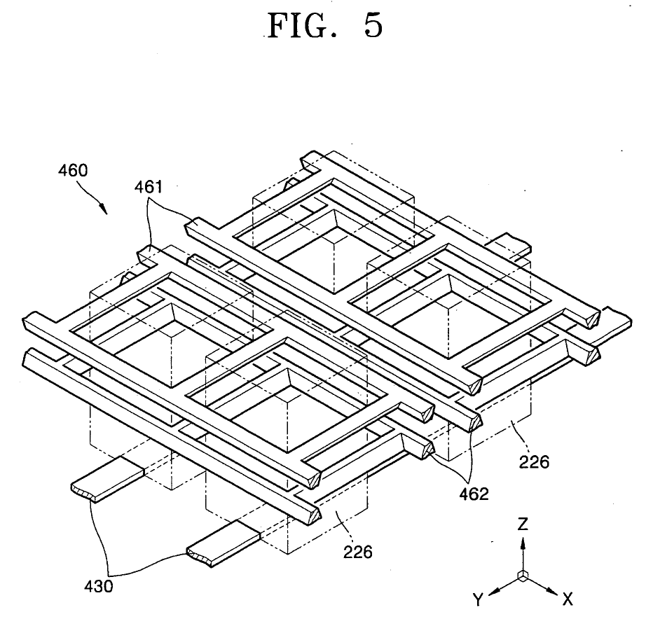

FIG. 5 is an exploded perspective view of the pairs of discharge sustaining electrodes 460 of FIG. 4. Referring to FIG. 5, the address electrodes 430 are arranged in the Y direction. The address electrodes 430 have strip shapes extending across the discharge cells marked with dotted lines.

The X electrodes 461 are arranged across the address electrodes 430. The X electrodes 461 are arranged in a square shape around the respective discharge cells so as to have ladder structures sequentially interconnected around the adjacent discharge cells arranged in the X direction. The same voltage is supplied to the adjacent X electrodes 461 arranged in the X direction. The X electrodes 461 arranged in the Y direction are separated from each other and supplied with different voltages.

The Y electrodes 462 are separately arranged under the X electrodes 461 to be parallel with the X electrodes 461. Like the X electrodes 461, the Y electrodes 462 have ladder structures sequentially interconnected around the adjacent discharge cells arranged in the X direction.

The X and Y electrodes 461 and 462 have sectional areas that gradually become larger from opposite portions where a discharge starts toward the outside. Thus, the section areas of the X electrodes 461 have an inverse trapezoid shape, and the sectional areas of the Y electrodes 462 have a trapezoid shape in the Z direction.

As described above, the X and Y electrodes 461 and 462 are buried in the dielectric wall 450 to be spaced apart from each other. The X and Y electrodes 461 and 462 can be formed of a metallic material having a high conductivity, for example, Ag paste.

The pairs of discharge sustaining electrodes 460 can include a plurality of X electrodes and a plurality of Y electrodes, or can include at least a plurality of X electrodes or at least a plurality of Y electrodes depending on whether the PDP 400 is an opposite discharge PDP or a surface discharge PDP.

The X and Y electrodes 461 and 462 arranged around the adjacent discharge cells in the direction (X direction) across the address electrodes 430 can be trapezoids or squares. Also, the adjacent X electrodes 461 and the adjacent Y electrodes 462 can be interconnected by conductive connection members.

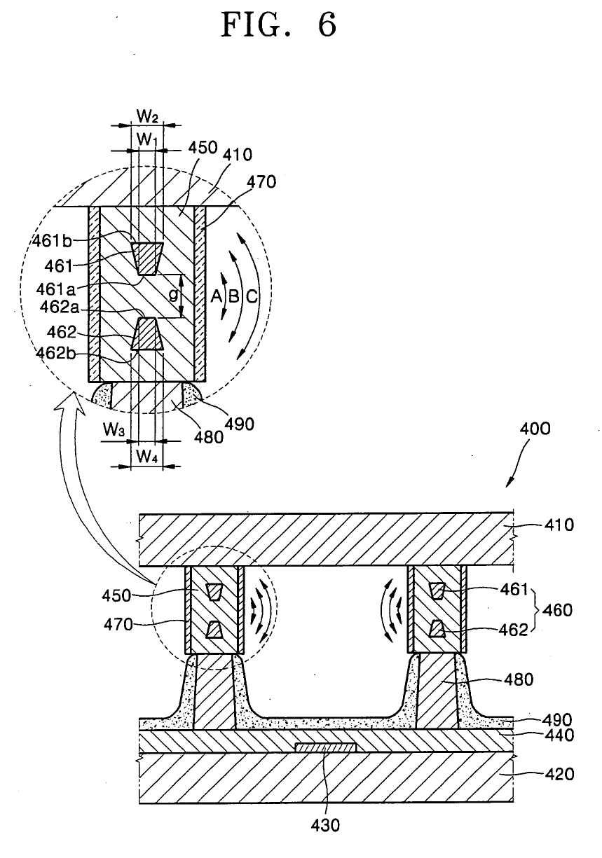

FIG. 6 is a cross-sectional view of a unit discharge cell with which the PDP 400 is combined. Referring to FIG. 6, an address electrode 430 is arranged on the inner surface of the rear substrate 420 so as to be buried in the dielectric layer 440.

The dielectric wall 450 is arranged between the front and rear substrates 410 and 420 to define the unit discharge cell, and X and Y electrodes 461 and 462 are separately arranged inside the dielectric wall 450.

The barrier rib 480 is arranged between the dielectric wall 450 and the rear substrate 420 so as to have a shape corresponding to the dielectric wall 450, and the R, G, and B phosphor layers 490 are formed on the inner surface of the barrier rib 480 in each discharge cell.

The R, G, and B phosphor layers 490 are respectively formed of different fluorescent materials. In other words, the R phosphor layer can be formed of (Y,Gd)BO₃;Eu⁺³, the G phosphor layer can be formed of Zn₂SiO₄:Mn²⁺, and the B phosphor layer can be formed of BaMgAl₁₀O₁₇:Eu².

The X and Y electrodes 461 and 462 have sectional areas that become gradually larger from the portions where a discharge starts toward the outside. In other words, the sectional areas of the X and Y electrodes 461 and 462 become gradually larger from the center of the dielectric wall 450 toward the edge thereof in which the front and rear substrates 410 and 420 are arranged.

In more detail, widths W₁ of one ends 461a of the X electrodes 461 opposite to the Y electrodes 462 are narrower than widths W₂ of the other ends 461b of the X electrodes 461. As the X electrodes 461 are away from the Y electrodes 462, the sectional areas of the X electrodes 461 increase.

Widths W₃ of one ends 462a of the Y electrodes 462 opposite to the X electrodes 461 are narrower than widths W₄ of the other ends 462b of the Y electrodes 462. Thus, as the Y electrodes 462 are away from the X electrodes 461, the sectional areas of the Y electrodes 462 increase. As the X electrodes 461 are adjacent to the front substrate 410, the sectional areas of the X electrodes 461 increase. As the Y electrodes 462 are adjacent to the rear substrate 420, the sectional areas of the Y electrodes 462 increase.

Accordingly, as discharge distances of the X and Y electrodes 461 and 462 with respect to the portions where the discharge starts increases, the sectional areas of the X and Y electrodes 461 and 462 increase. Gaps between the X and Y electrodes 461 and 462 and the inner surface of the dielectric wall 450 gradually decrease in inverse proportion to the increase in the sectional area of the electrodes.

In other words, as a distance between the X and Y electrodes 461 and 462 and discharge gaps g where the discharge starts increase, the sectional areas of the X and Y electrodes 461 and 462 increase. Thus, although the distance between the X and Y electrodes 461 and 462 increases, an electric field can be compensated for.

The operation of the PDP 400 having the above-described structure is described below with reference to FIG. 6.

When an external power source supplies a predetermined address voltage between the address electrode 430 and the Y electrodes 462, a discharge cell which is to emit light is selected and a wall charge is accumulated on the Y electrode 462 of the selected discharge cell.

When a positive voltage is supplied to the X electrodes 461 and a voltage relatively higher than the positive voltage is supplied to the Y electrodes 462, a voltage difference between the X and Y electrodes 461 and 462 causes the wall charge to move.

The moving wall charge collides with discharge gas atoms inside a discharge space to produce a discharge so as to generate plasma. The discharge is highly likely to be produced from gaps between the X and Y electrodes 461 and 462 around which a strong electric field is formed.

Since the X and Y electrodes 461 and 462 are formed along four sides of the discharge space, the discharge is highly likely to be produced.

If the voltage difference between the X and Y electrodes 462 is fully sustained as time elapses, the electric field between the X and Y electrodes 461 and 462 is gradually strongly concentrated so as to be diffused into the entire discharge space.

In the present embodiment, the discharge is produced from the four sides of the discharge space and then diffused to the center of the discharge space. Thus, the diffusion range of the discharge considerably increases. The plasma is generated by the discharge in a ring type along the side of the discharge space and then diffused to the center of the discharge space. Thus, the volume of the plasma is considerably increased, and thus an amount of visible light is increased. Also, as the plasma is concentrated on the center of the discharge space, a space charge can be used. As a result, a low drive voltage is possible, and the luminous efficiency can be improved.

When the voltage difference between the X and Y electrodes 461 and 462 is lower than a discharge voltage after the discharge is produced using the above-described method, the discharge is not produced any more, and space and wall charges are formed in the discharge space. If the polarities of the voltages supplied to the X and Y electrodes 461 and 462 are interchanged, a discharge is re-produced due to the wall charge. In other words, if the polarities of the X and Y electrodes 461 and 462 are interchanged, an initial discharge process is repeated. The discharge is stably produced due to the repetition of this process.

Ultraviolet light rays generated by the discharge excite fluorescent materials of the R, G, and B phosphor layers 490 coated in each discharge space. The visible light is obtained through this process. The visible light is radiated to the discharge space so as to realize an image.

A discharge start phenomenon is described in more detail as follows. When a sustaining voltage is supplied between the X and Y electrodes 461 and 462, an electric field is formed between the X and Y electrodes 461 and 462. When the sustaining voltage is supplied between the X and Y electrodes 461 and 462 in an initial state, a discharge starts in the vicinity of the discharge gaps g due to the wall charge. Thus, the wall charge in the vicinity of the discharge gaps g does not stick on the dielectric wall 450 any more. As a result, the discharge does not occur at position A any more but rather at position B. When the discharge does not occur in position B, the discharge occurs in position C. The discharge is diffused to the ends 461b and 462b of the X and Y electrodes 461 and 462 according to this method.

However, as the discharge is diffused, this diffusion is disadvantageous to the discharge. In other words, the same voltage is supplied to the X and Y electrodes 461 and 462, but the discharge distance between the X and Y electrodes 461 and 462 increases. Thus, as the electric field is away from the discharge gaps between the X and Y electrodes 461 and 462, the strength of the electric field is weakened. As the X and Y electrodes 461 and 462 are away from the discharge gaps, the sectional areas of the X and Y electrodes 461 and 462 are increased. Thus, the electric field can be compensated so as to sustain a stable discharge.

As described above, in a PDP according to the present invention, as discharge distances are away from gaps of discharge electrodes, sectional areas of the discharge electrodes can be increased. Thus, an electric field can be prevented from being weakly formed. As a result, a stable sustaining discharge can be achieved.

Also, a wide voltage margin can be secured. Thus, the PDP can achieve a stable discharge.

Moreover, a discharge can be realized along a side of a discharge space. Thus, a discharge area can be increased.

Furthermore, discharge electrodes cannot be formed on an inner surface of a substrate opposite to the discharge space. Also, a dielectric layer cannot be formed to bury the discharge electrodes. Thus, an aperture ratio can be greatly improved.

While the present invention has been particularly shown and described with reference to exemplary embodiments thereof, it will be understood by those of ordinary skill in the art that various modifications in form and detail can be made therein without departing from the spirit and scope of the present invention as defined by the following claims.

1. A Plasma Display Panel (PDP) comprising:
a front substrate;
a rear substrate opposite to the front substrate;
a dielectric wall arranged between the front and rear substrates to define discharge cells together with the front and rear substrates;
pairs of discharge sustaining electrodes separately arranged along respective discharge cells and including a plurality of X electrodes and a plurality of Y electrodes buried in the dielectric wall;
address electrodes arranged on the rear substrate and buried in a dielectric layer; and
first color, second color, and third color phosphor layers coated in the discharge cells;
wherein sectional areas of the X and Y electrodes vary with discharge distances of the X and Y electrodes with respect to portions of the X and Y electrodes where a discharge starts.

2. The PDP of claim 1, wherein the sectional areas of the X and Y electrodes increase from facing portions of the X and Y electrodes toward opposing portions.

3. The PDP of claim 1, wherein the sectional areas of the X and Y electrodes increase from a center of the dielectric wall toward an edge of the dielectric wall.

4. The PDP of claim 1, wherein, as the discharge distances of the X and Y electrodes with respect to the portions from which the discharge starts increase, gaps between the X and Y electrodes and an inner surface of the dielectric wall decrease.

5. The PDP of claim 1, wherein the X electrodes are arranged adjacent to the front substrate, the Y electrodes are arranged adjacent to the rear substrate, and the X and Y electrodes are separately arranged up and down.

6. The PDP of claim 5, wherein, as the X electrodes approach the front substrate, the sectional areas of the X electrodes increase, and as the Y electrodes approach the rear substrate, the sectional areas of the Y electrodes increase.

7. The PDP of claim 1, wherein the pairs of discharge sustaining electrodes extend in one direction of the front substrate, and the address electrodes extend across the pairs of discharge sustaining electrodes.

8. The PDP of claim 1, wherein the X electrodes comprise ladder structures sequentially interconnected around the discharge cells.

9. The PDP of claim 1, wherein the Y electrodes comprise ladder structures sequentially interconnected around the adjacent discharge cells arranged in one direction of the front substrate.

10. The PDP of claim 1, further comprising a barrier rib arranged between the dielectric wall and the rear substrate to have a shape corresponding to the dielectric wall, wherein the red, green, and blue phosphor layers are coated on an inner surface of the barrier rib.

11. The PDP of claim 1, further comprising a protective layer arranged on an inner surface of the dielectric wall to increase an emission of secondary electrons.

12. The PDP of claim 1, wherein the first color, second color, and third color phosphor layers respectively comprise red, green, and blue phosphor layers.
